(19) United States
(12) Patent Application Publication
(10) Pub. No.: US 2025/0176072 A1
(43) Pub. Date: May 29, 2025

(54) BUILD MATERIAL POWDER CURING STATION

(71) Applicant: Desktop Metal, Inc., Burlington, MA (US)

(72) Inventors: George HUDELSON, Burlington, MA (US); Peter ZUMMO, Burlington, MA (US); Robert DOWNING, Burlington, MA (US); Eric WALKAMA, Burlington, MA (US); Sean BREHENY, Burlington, MA (US); Timur STAROBINETS, Burlington, MA (US)

(21) Appl. No.: 18/839,740

(22) PCT Filed: Feb. 15, 2023
(86) PCT No.: PCT/US2023/013079

§ 371 Date: Aug. 20, 2024

Related U.S. Application Data
(60) Provisional application No. 63/312,282, filed on Feb. 21, 2022.

(51) Int. Cl. H05B 3/00; B22F 10/14; B22F 12/13; B28B 1/00; B28B 17/02; B29C 64/165; B29C 64/314; B33Y 40/10

(52) U.S. Cl. CPC H05B 3/0038; B22F 12/13; B28B 17/026; B29C 64/314; B33Y 40/10; B22F 10/14; B28B 1/001; B29C 64/165

(57) ABSTRACT

A system and method of curing build material powder. An amount of build material powder is placed in a container sealable with respect to a gaseous atmosphere present about the exterior of the container. The container is installed in a powder curing apparatus which includes a heating system and an agitation system. The heating system heats the build material powder to a temperature profile while the agitation system causes a portion of the build material powder in the container to be conveyed away from an interior surface of the container, and a second portion of the build material powder is conveyed toward an interior surface of the container.

### RELATED APPLICATIONS

This application is a US National Stage Application, filed under 35 U.S.C. § 371, of International Application PCT/US2023/013079, filed on Feb. 15, 2023 and claims priority to U.S. Patent Application 63/312,282, filed on Feb. 21, 2022; the contents of the above applications are incorporated by reference herein in their entirety.

### TECHNICAL FIELD

Various aspects of the present disclosure relate to a curing build material powder used in binder jetting additive manufacturing.

### BACKGROUND OF THE DISCLOSURE

Binder jetting is an additive manufacturing technique by which a thin layer of powder (e.g. 65 μm) is spread onto a bed, followed by deposition of a liquid binder in a 2D pattern or image that represents a single “slice” of a 3D shape. After deposition of binder, another layer of powder is spread, and the process is repeated to form a 3D volume of bound material within the powder bed After printing, the bound part may be, in reversible order, cured or crosslinked to strengthen the binder, and removed from the excess build material powder.

Build material powder used in binder jetting presents numerous challenges. The specific chemical composition (such as the base material from which the build material is comprised or mixture of base materials), surface chemistry, water content, physical aspects (such as the size distribution of particles in the build material powder, shape of the particles, roughness of the particles, and the like), storage condition and history, processing history, and other attributes of the build material powder may affect the rheological behavior of build material powder during various aspects of the binder jetting process. Build material powder that is new or that has been previously used in printing several times may require curing prior to use in a binder jetting process. Further, certain materials in powder form represent an explosion and/or health hazard. It is thus desirable for a system accomplishing powder processing to minimize (or substantially reduce to an acceptable level of safety) the need to manually transfer build material powder between different containers while allowing for expedient curing and other mechanisms of treatment in preparation for use in a binder jetting additive manufacturing process.

### SUMMARY

Disclosed is a curing station and method of curing build material powder. A curing station includes a heating system and an agitation system. In certain embodiments, a cooling system may also be included. A container is loaded into the curing station and the heating system applies heat to the build material powder in the container to cure it. The agitation system imparts motion to the build material powder to create relative motion between powder particles, and between powder particles and the boundaries of the container containing the build material powder. A cooling system cools the build material powder after the curing operation to accelerate the availability of the build material powder for use in a subsequent binder jetting additive manufacturing process.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 is a schematic diagram of the components of a curing station according to an exemplary embodiment.

FIGS. 2A-O depict a first curing station according to an exemplary embodiment.

FIGS. 3A-B depict a container for use with curing stations according to an exemplary embodiment.

FIGS. 4A-M depict a curing station during a curing process according to an exemplary embodiment.

### DETAILED DESCRIPTION

In the process of binder jetting additive manufacturing, a build material powder is delivered to and spread upon a build surface and a binding agent (or binder or ink) is deposited on the build material powder to at least partially bind the build material powder to form a slice of a 3D object. By repeating the steps of delivering a build material powder, spreading a build material powder, and depositing a binder corresponding to a desired image, a 3D structure may be formed. This process is understood to occur in a binder jetting printer (or binder jet printer).

The build material powder is central to the performance of the binder jet printing process. Specific attributes of the build material powder, in combination with certain aspects of the binder jet printer, in certain embodiments, will affect the process window (e.g., the freedom the operator of the binder jet printer may have to vary certain process parameters such as a print speed, a type of binder (or ink), a layer height, an atmosphere within the printer, among other attributes) in which the printer may produce objects of acceptable quality. In certain embodiments, it may be required to alter, condition, treat, or otherwise “cure” a build material powder to alter certain powder attributes.

A variety of powders may be used as build material powder. In certain embodiments, the build material may be any finely divided material or powder. The finely divided material may be a metal, oxide ceramic, non-oxide ceramic, glass, cermet, organic material, carbide, nitride, or any mixture, according to certain embodiments.

In certain embodiments, the build material may comprise a metallic powder. In certain embodiments, the metallic powder may comprise a pure element (such as elemental copper or iron). In certain embodiments, the metallic powder may comprise an alloy of metallic elements to form a specific grade of metal, such as 17-4 stainless steel, 316 stainless steel, 316L stainless steel, 4140 low alloy steel, Inconel 718, Inconel 625, 6061 aluminum, 7075 aluminum, Ti-6Al-4V titanium, F75 Co—Cr—Mo, or any other alloy capable of being produced in a powdered or finely-divided form. In certain embodiments, the metallic powder may comprise a mixture of powdered metallic elements purposed to achieve the desired chemical specification of an alloyed metal (for example, a mixture including elemental Co, Cr, and Mo powders to form an F75 alloy, or a mixture including Fe, Cr, V, C, Mn, Si, and Ni to form a stainless steel). In certain embodiments, the build material may comprise a metallic powder where the metal is a refractory metal (such as tungsten, tantalum, niobium, rhenium, molybdenum, hafnium, zirconium, or the like).

In certain embodiments, the build material may comprise a ceramic powder. In certain embodiments, the ceramic powder may comprise alumina, zirconia, yttria-stabilized zirconia, mullite, silica, chromia, spinel, and the like. In certain embodiments, the build material may be a mixture of ceramic powders (for example, silica and alumina, or magnesium oxide and alumina).

In certain embodiments, the build material may be naturally derived, as an organic material. In certain embodiments, the organic material may comprise a wood flour, sawdust, cellulosic fiber, or the like.

In certain embodiments, a curing process may be employed to vary the properties of a build material powder. In certain embodiments, the curing process may include such process features as (1) the application of heat to a build material powder, (2) the agitation of a build material powder, (3) the maintenance of a controlled atmosphere about the build material powder, (4) the flow and withdrawal of gases to an area (or volume) in which the build material powder is present, (5) the creation of a vacuum in a volume in which the build material powder is present, (6) the removal of heat (or cooling) of the build material powder, or other process features as described and disclosed herein.

In certain embodiments, the application of heat may be used to change a state of the build material powder. In certain embodiments, molecules, or any other matter may be stuck or adhered to the surface of the build material powder, and may affect the ability of the build material powder to flow, pack, compact, sinter, or interact with at least some aspect of the binder jet printing process. Changing a state of a build material powder may include changing the amount of moisture on the surface of the build material powder, in certain embodiments. For example, the build material powder may retain some amount of water vapor, bulk water, chemisorbed water, or any other type of moisture on the surface of the build material powder, In certain embodiments, the application of heat may result in, or at least assist in, the removal or decrease in (as compared to the build material powder prior to the application of heat) an amount of moisture present on the surface of the build material powder.

In certain embodiments, the surface of the build material powder may retain, be at least partially covered by, or otherwise be attached to organic molecules such as oils, waxes, alcohols, and the like. In certain embodiments, the application of heat may result in, or at least assist in, the removal or decrease in (as compared to the build material powder prior to the application of heat) an amount of organic molecules present on the surface of the build material powder.

In certain embodiments, the curing of build material powder may include the agitation of the build material powder. The agitation of the build powder may serve to mix the components of the build material powder. The agitation of the build material powder may be performed in concert with any other curing process feature such as heating, in certain embodiments. In certain embodiments including the agitation of the build material powder, and without being bound by theory, the agitation may physically affect the surface of the build material powder (perhaps by altering the surface roughness). In certain embodiments, the agitation of the build material powder may aid in the distribution of heat (when the powder, or any container in which the powder is contained, is heated or cooled). In certain embodiments, the agitation of the build material powder may aid in the removal of species (such as water, water vapor, oils, alcohols, other organics, and the like) from the surface of the build material powder by reasons that may include: aiding in the transport and mixing of the build material powder with the gaseous environment in the drum, and providing alternating exposure of the build material powder (via the agitation) to gaseous species with the drum.

In certain embodiments, the curing of the build material powder may include the control of the gaseous atmosphere about the build material powder. In certain embodiments, the build material powder may be exposed to a specific gaseous atmosphere. The gas atmosphere may be chosen to modify the surface of the build material powder by, for example, oxidation, carburizing, or nitriding. The specific gas atmosphere utilized may depend upon the build material powder.

In certain embodiments, the gaseous atmosphere to oxidize a powder may include or primarily consist of an oxidizing gas such as oxygen, air, water vapor, carbon monoxide, or carbon dioxide. In certain embodiments, for the case of iron-contain metals and alloys including, but not limited to, carbonyl iron, iron, carbon steels, midcarbon steels, tool steels, stainless steels, and the like, an oxidizing gas may be provided, optionally with an amount of heat or agitation to oxidize the build material powder and increase the amount of oxygen the powder. One skilled in the art will appreciate that a range of oxidizing gases and temperatures may be employed, and the range may dependent upon the composition of the alloy which is intended to be cured. In other embodiments, oxidation may be desired for other classes of materials including alloys of nickel, cobalt, chromium, titanium, aluminum, gold, silver, platinum, combinations of metals, or generally any alloy which may be employed for binder jet printing.

In certain embodiments, the gaseous atmosphere to nitride a powder may include or primarily consist of a nitriding gas such as ammonia or nitrogen. In certain embodiments, the gaseous atmosphere to carburize a powder may include or primarily consist of methane, acetylene, carbon monoxide, or carbon dioxide.

In certain embodiments, the curing of the build material powder may increase the oxygen content by between 10 and 1000 parts per million. In certain embodiments, the curing of the build material powder may increase the oxygen content by between 100 and 10,000 parts per million. In certain embodiments, the curing of the build material powder may increase the oxygen content by between 1,000 and 100,000 parts per million. In certain embodiments, the curing of the build material powder may negligibly affect the oxygen content of the build material powder, such that the oxygen content before and after curing is statistically insignificant.

In certain embodiments an inert gas may be used, such as argon or helium. In certain embodiments, nitrogen gas may be used, and may be considered inert for iron-based powders at temperatures less than 250 degrees centigrade.

In certain embodiments, the build material powder may be prohibited from contacting a specific gaseous atmosphere. In certain embodiments, a build material powder may be prevented from contacting oxygen or any oxygen containing gas, or oxygen above a pre-determined concentration. In some embodiments, the concentration of oxygen to which a build material powder is exposed may be controlled to be less than between 100 and 10,000 parts per million. In other embodiments, the concentration of oxygen to which a build material powder is exposed may be controlled to be less than 2 percent. In certain embodiments a build material powder may be prevented from contacting water vapor or any water vapor containing gas. One skilled in the art will appreciate that different alloys will exhibit different sensitivities and reactivities toward identical atmospheres.

In certain embodiments, a gaseous atmosphere may be substantially prevented from contacting build material powder, such as by providing a vacuum.

In certain embodiments, any combination of process features may be included to cure the build material powder. In certain embodiments, a first set of process features may be utilized to cure a build material powder in an initial state (the initial state may be the state the powder is received in from a supplier (a “virgin” powder), in certain embodiments), and a second set of process features may be utilized to cure a build material powder in a following state (the following state may be the state of the powder after it has been used in a binder jet printing process, in certain embodiments).

In this disclosure, several embodiments are described to accomplish build material powder curing.

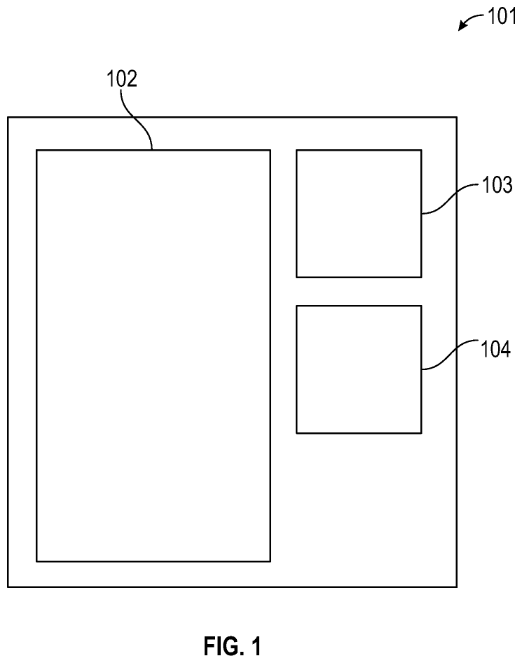

With reference now to FIG. 1, a curing station 102 is configured to receive a container of build material powder. A heating system 103 is configured to heat the build material powder during a powder curing operating and a cooling system 104 to cool the build material after the powder curing operating. In the present disclosure the term “cure” includes operations that result in oxidization, nitration, cross-linking, de-agglomeration and drying (removal of water or other liquids) of build material powder.

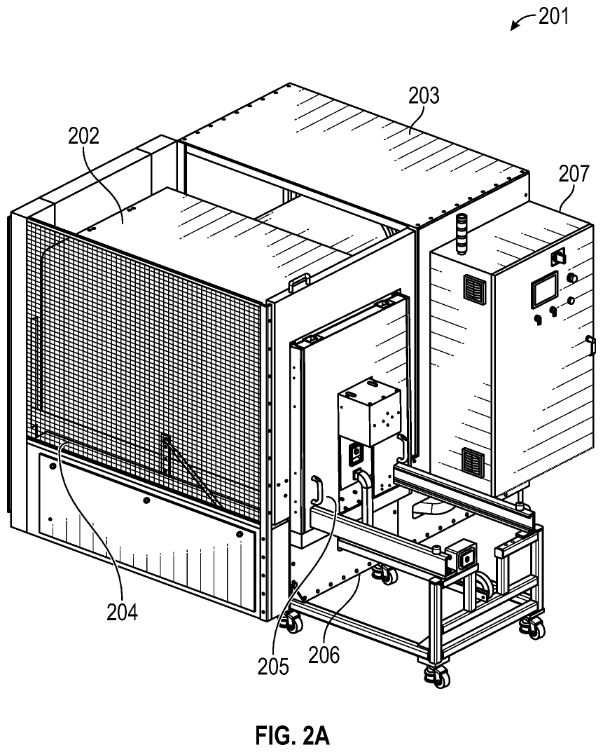

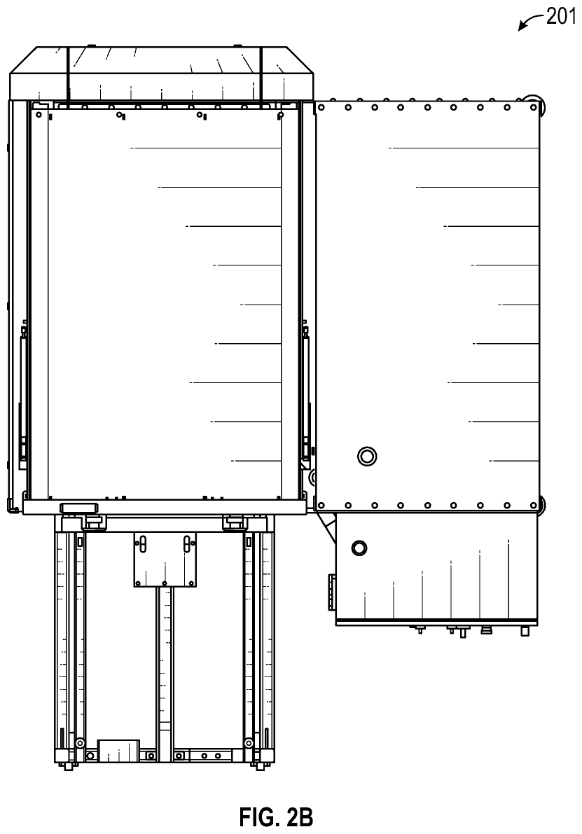

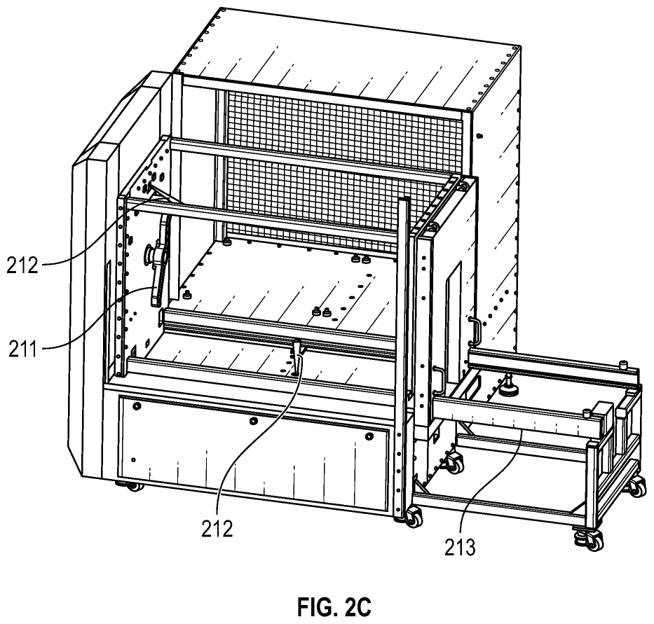

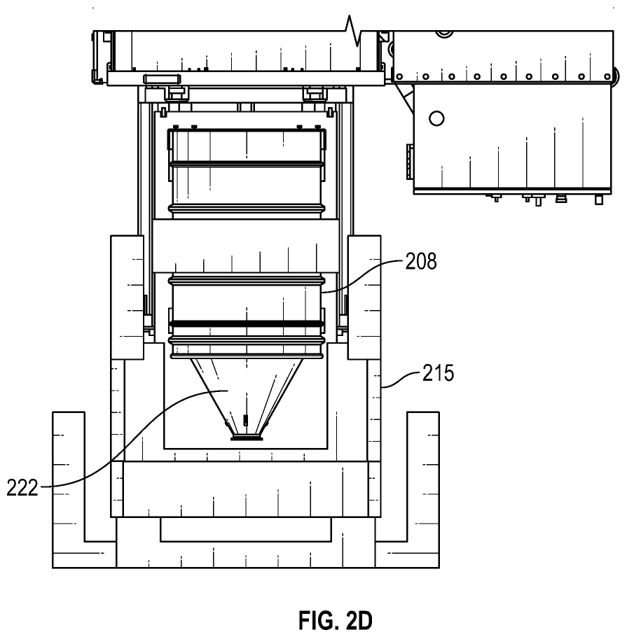

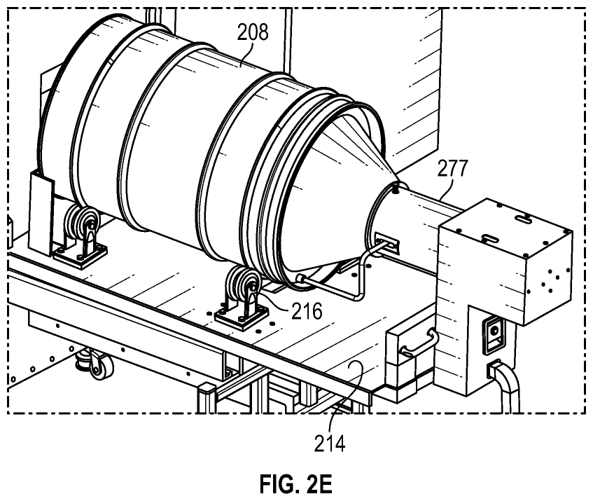

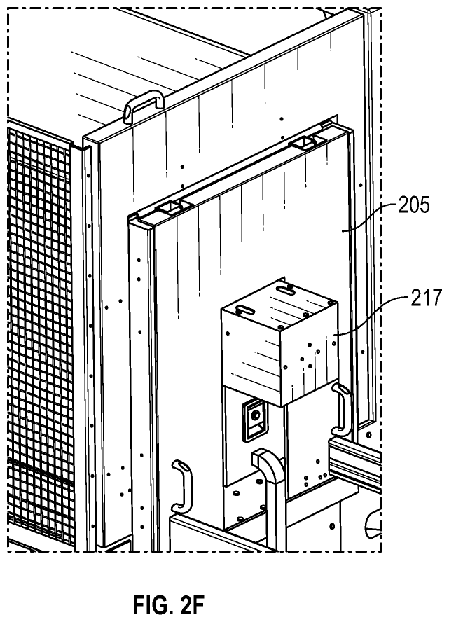

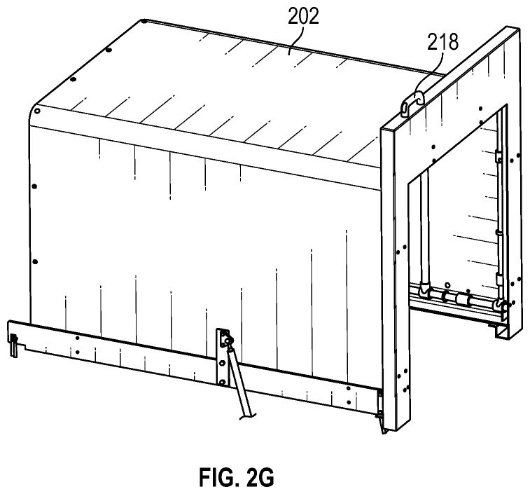

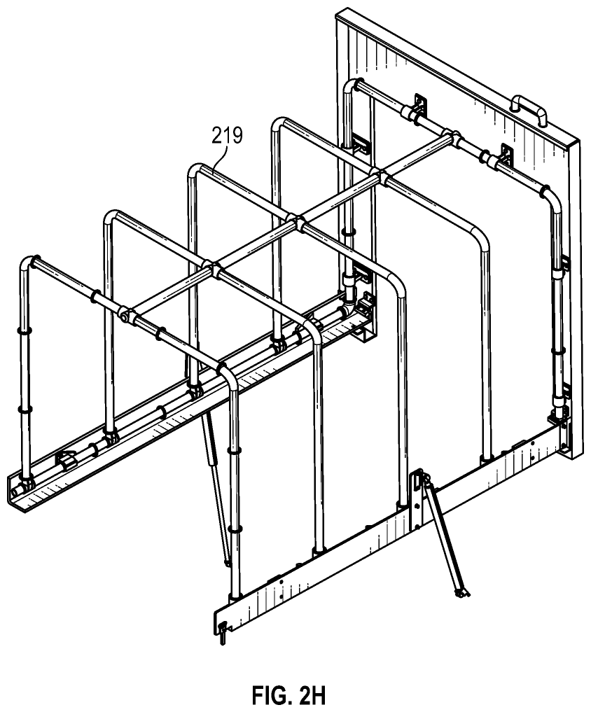

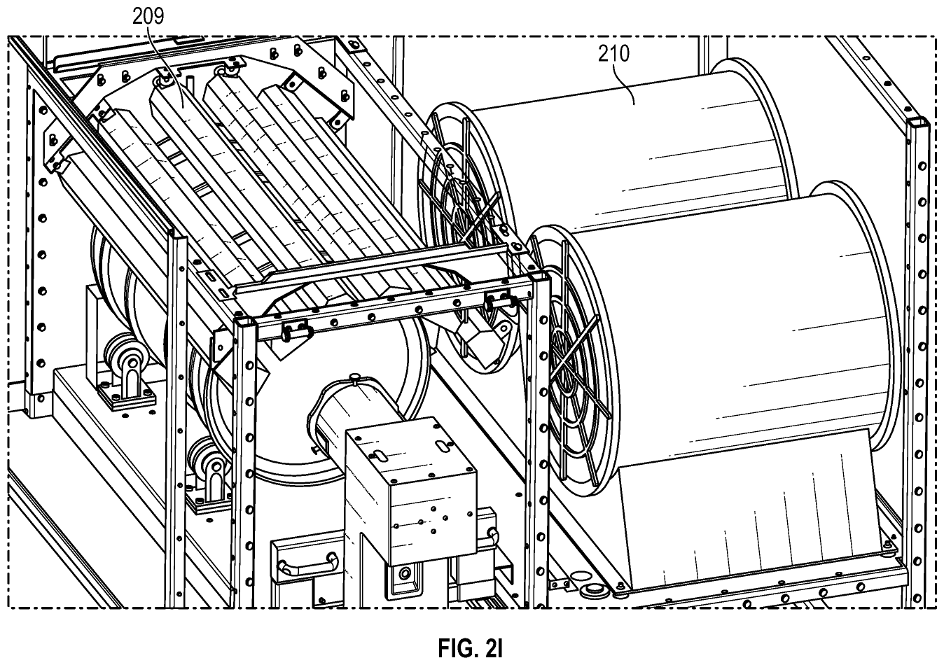

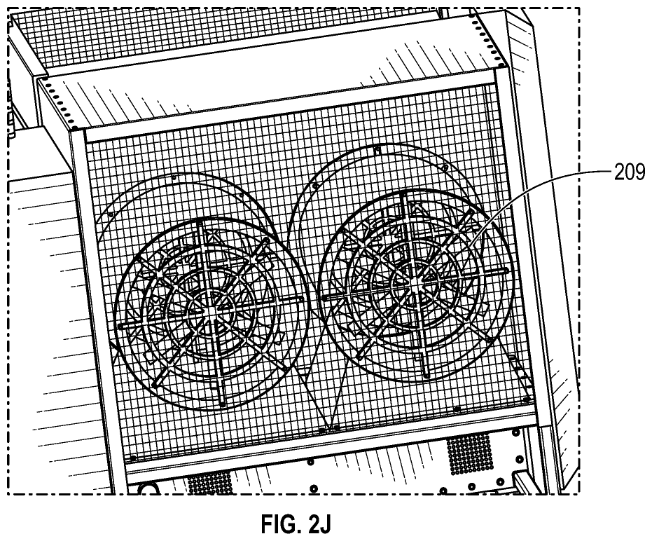

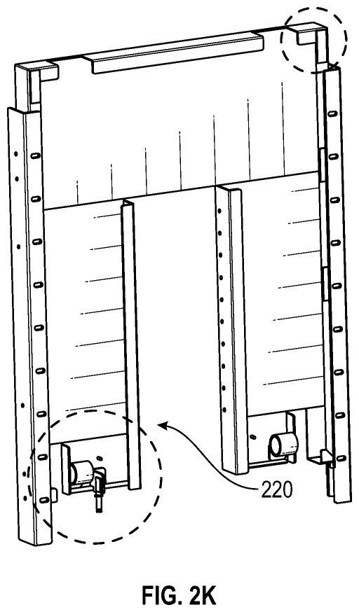

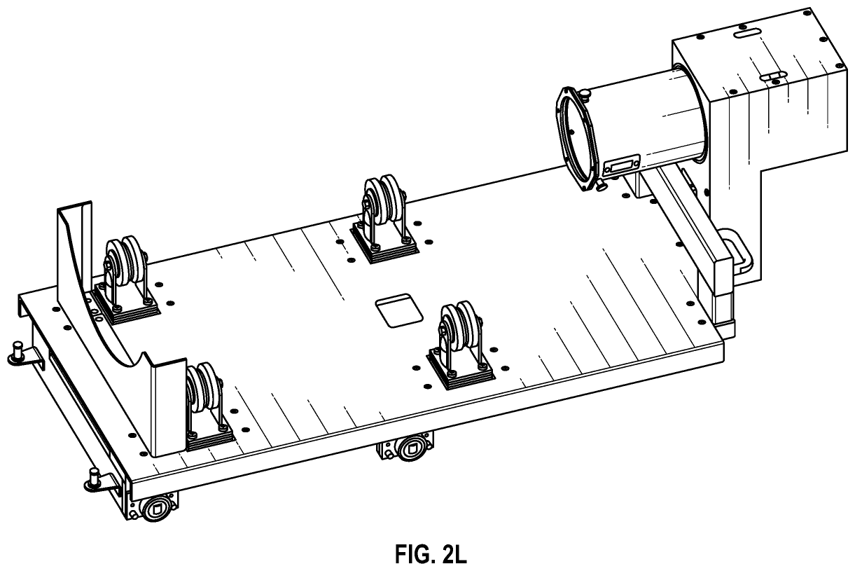

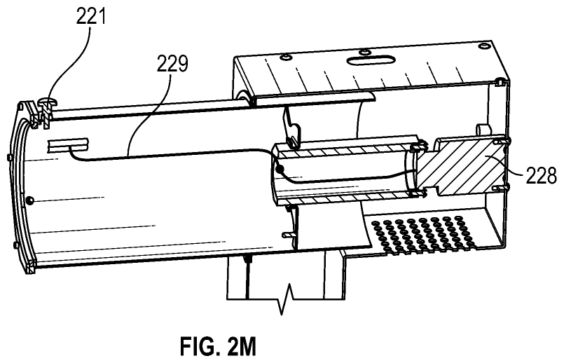

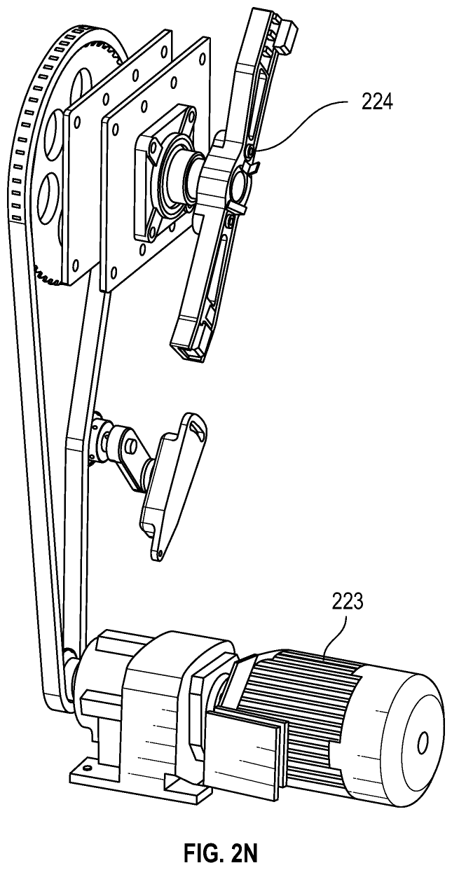

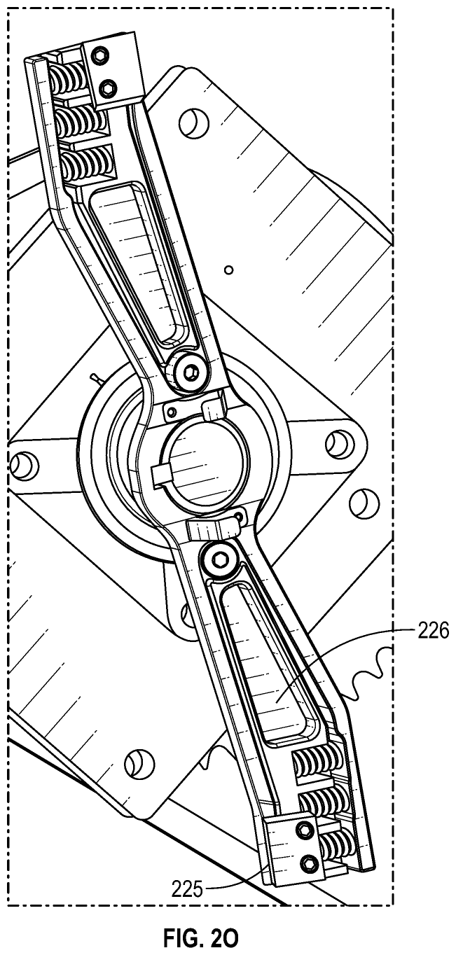

With reference now to FIG. 2A, a curing station 201 is configured to heat build material powder in a container under a curtain hood 202. The curtain hood acts to reflect and contain heat. In the embodiment, a cooling system rests under a top panel 203. A protective grate 204 prevents user contact with the curtain hood 202 which will be hot during a heating cycle. A sliding door 205 provides access to the internal processing chamber of the curing station 201 when open. A railed receiving area 206 is configured to receive containers of build material powder. A user interface 207 allows the user to control the curing processes. FIG. 2B is a top view of the powder curing station 201.

FIG. 2C depicts a cutaway of the interior of the curing station 201. Temperature sensors 212 monitor surface temperatures of a container 208 (see FIG. 2I) which can be correlated to the temperature of build material powder within the container 208. A rail system 213 is configured to allow a slidable cart 214 (see FIG. 2E) to be traversed between an inner stop position and an outer stop position.

FIG. 2D depicts a top view of container 208 being deposited into the curing station by a transport apparatus 215.

FIG. 2E depicts the slidable cart 214 in an outer stop position, with container 208 having circumferential rings resting on a plurality of rollers 216, allowing the container 208 to be freely rotatable along a longitudinal axis when in a horizontal position. A mount 217 is configured to interface with a nozzle of the container 208 and index the container 208 for curing operations. FIG. 2F depicts the sliding door 205 having been closed and the mount 217 extending out of the sliding door 205.

FIG. 2G shows the curtain hood 202 detached from the powder curing station 201. A handle 218 facilitates moving the curtain hood out 202 of position after the curing operation to facilitate cooling. In the embodiment, the curtain hood 202 is rotatable. FIG. 2H depicts a frame 219 of the curtain hood 202. FIG. 2I shows a container 208 of build material powder installed for a curing. Heating system 209 provides heat for the build material powder. In the embodiment of FIG. 2I the heating system 209 is a series of infrared heaters. Cooling system 210 provides cooling for the build material powder after a curing operation. FIG. 2J shows another view of cooling system 209, which in the embodiment is a set of cooling fans. FIG. 2K is depicts an interior of the sliding door 205 having an aperture 220 through which communication can be made been to the container 208 while curing operations are being done. FIG. 2L depicts the slidable cart 214 in greater detail. FIG. 2M depicts a cutaway view of the mount 217 wherein a number of indexing points 221 are configured to index against indexing stops 222 (See FIG. 2D) on the container 208. A cover 277 rotates with the drum, and serves to isolate the heaters from possible releases of powder from the drum opening. Cover 277 interfaces with the drum at points 222 (see FIG. 2D). A rotary union 228 serves to couple gas lines 229 between the rotating drum and the stationary gas supply or exhaust connection. FIG. 2N depicts an agitation system which in the embodiment includes a motor 223 and a rotation unit 224. As seen in FIG. 2O, a pair of contact pads 225 on spring-biased engagement arms 226 engage with complementarily shaped engagement surfaces on a rotation plate 227 on container 208.

A variety of methods and approaches may be utilized, either individually or in concert, to accomplish the heating of the drum. Heating may proceed by the application of electromagnetic radiation (e.g., radiation heat transfer), by the interaction of a fluid with a higher temperature than the object to be heated (convection heat transfer), by the direct (sustained or intermittent) contact between an object warmer than the drum and the drum (conduction heat transfer), or by any reasonable combination of these approaches.

In certain embodiments, and by way of non-limiting example, an assemblage of resistive heating elements (such as silicon carbide, molybdenum disilicide, kanthal, and the like) may be positioned with line of sight to the drum and may be further located with a fan, blower, or similar element to actuate gas positioned to provide a flow of gas to and toward the drum which first passes through the assemblage of resistive heating elements; in such an embodiment, the heating may be accomplished at least by (1) radiation heat transfer to the drum from the heating elements enabled by the line of sight between the heating elements and the drum, and (2) convection heat transfer by the act of the heating elements raising the temperature of the gas transiting to the drum, and the interaction of the hot gas with the drum surface, raising the temperature of the drum. As one skilled in the art will appreciate, the input power to the heating elements, the surface temperature of the heating elements, and the rate of gas flow will affect the heat transfer characteristics of the drum, the heat transfer characteristics including at least the steady-state temperature of the drum during heating and the transient heating characteristics (e.g., rate of heating as a function of time).

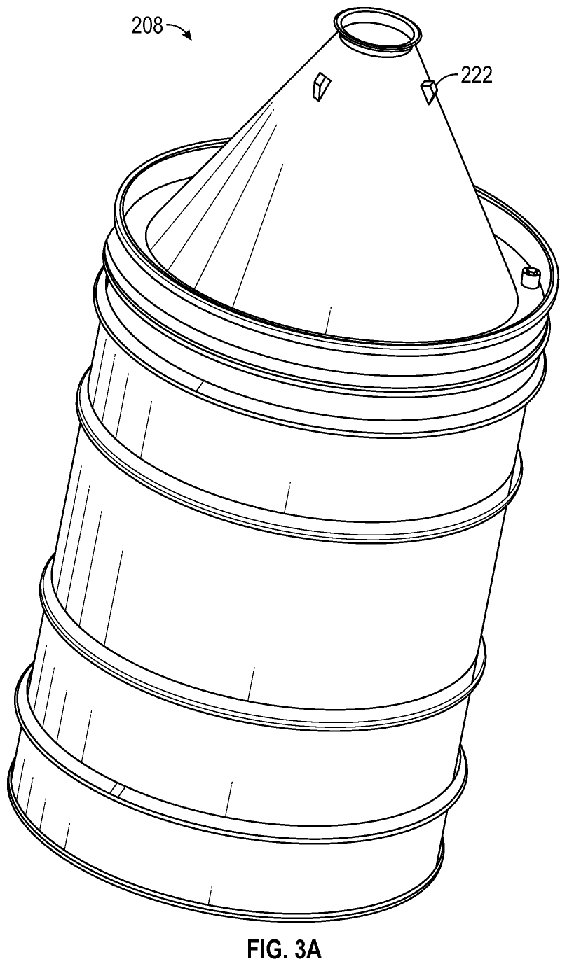

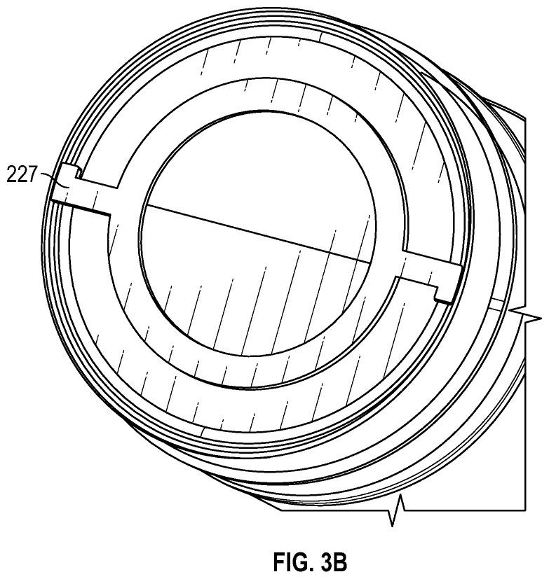

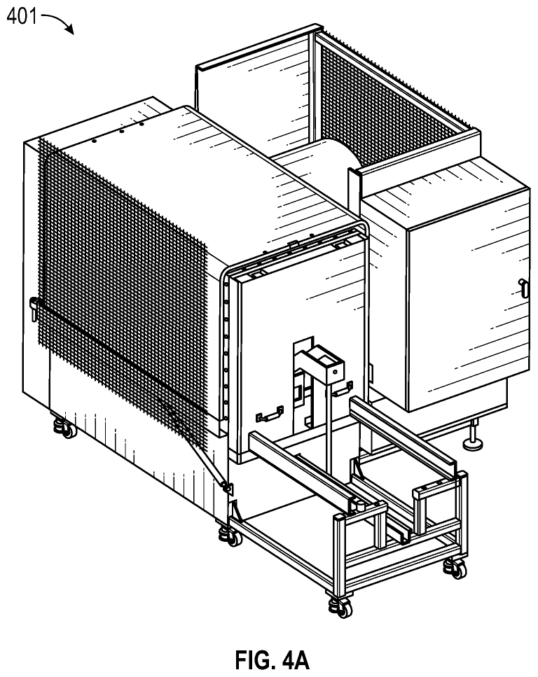

FIGS. 3A-B depicts an embodiment container 208 for build material in the form of a drum that is configured to interface with the curing station. During the curing process, the drum may be isolated from ambient air, for instance by via the gas ports providing a gas such as nitrogen or air.

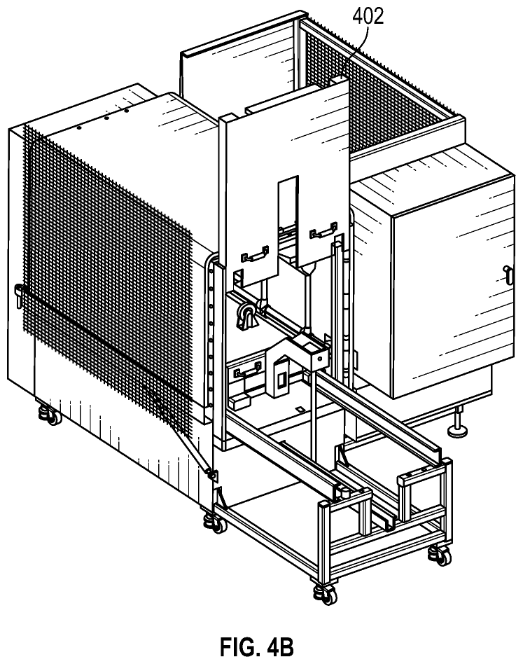

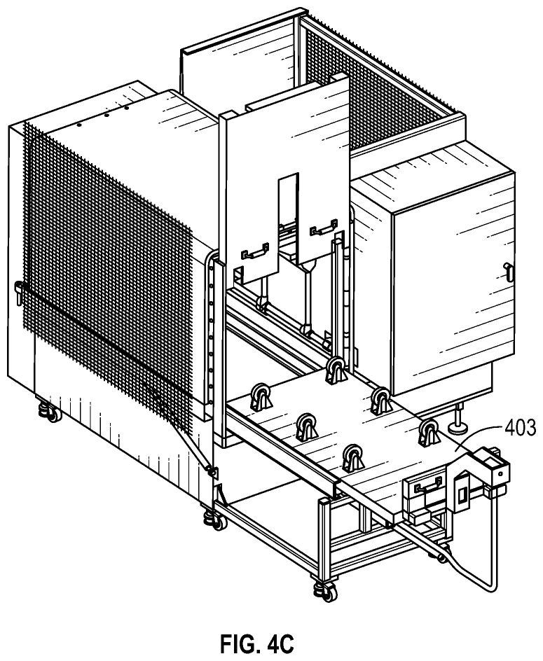

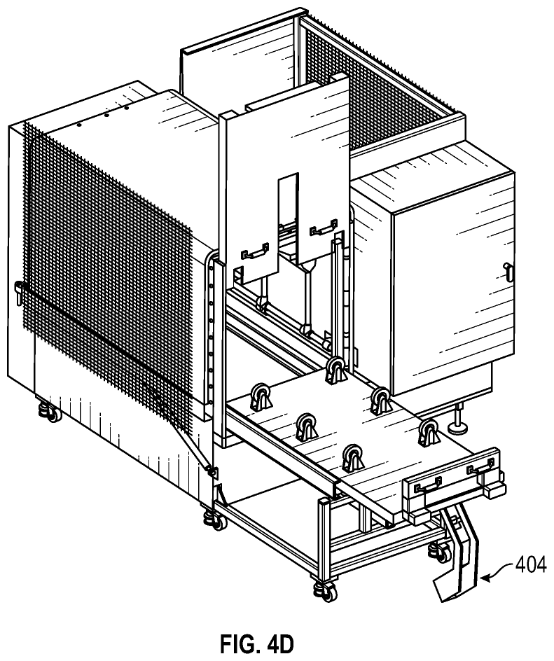

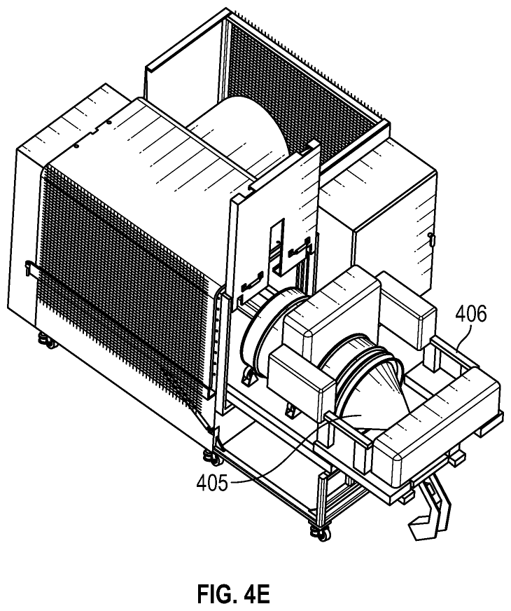

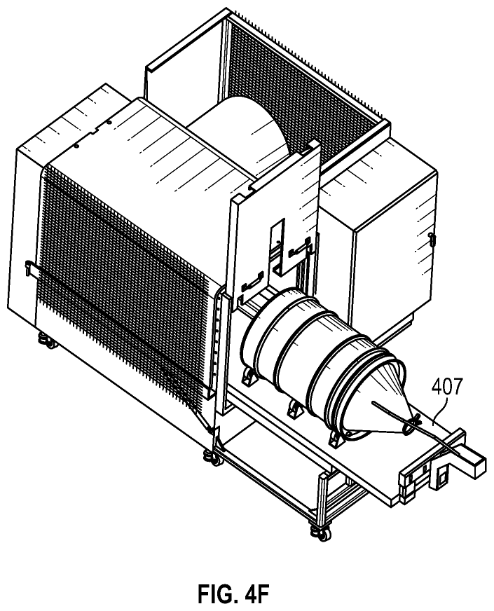

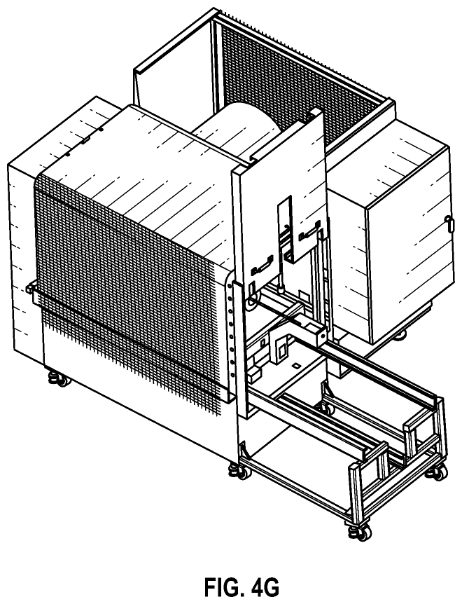

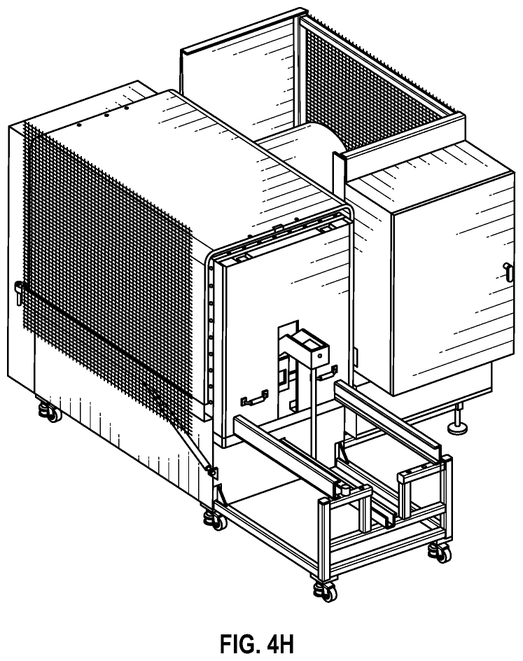

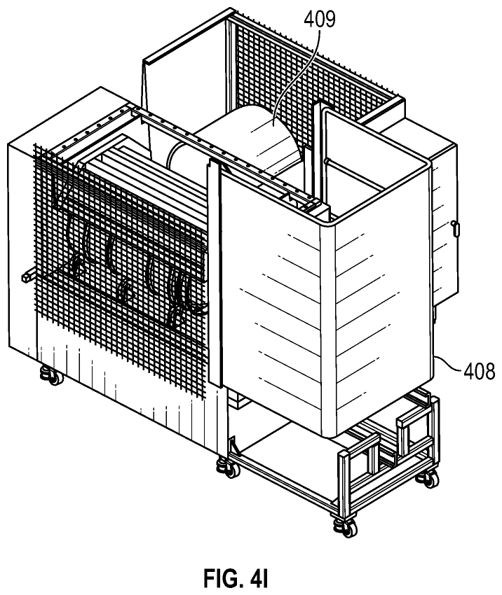

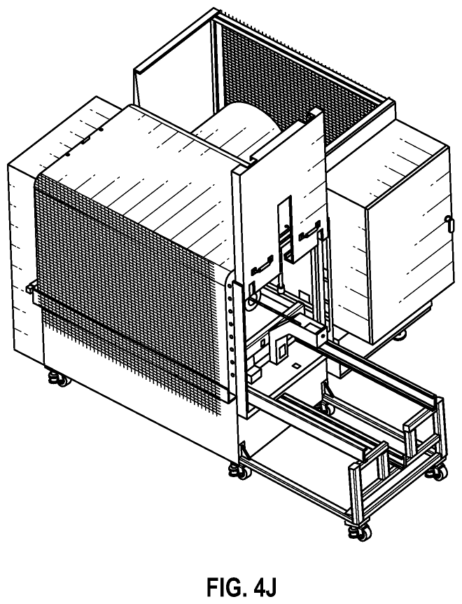

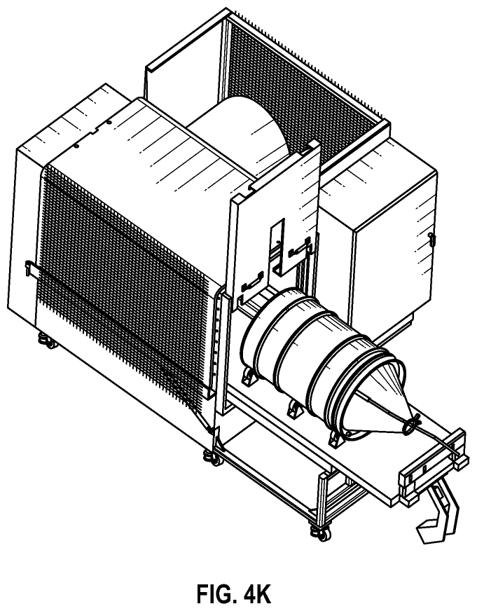

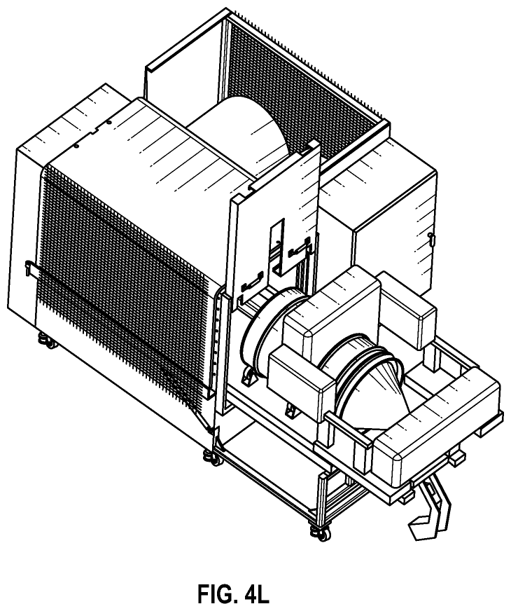

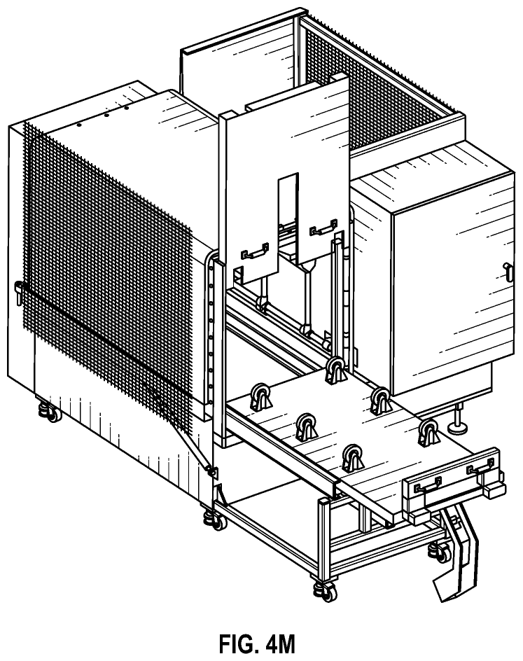

FIGS. 4A-M depicts the steps for operating a second embodiment curing station. FIG. 4A depicts a second embodiment curing station 401 prior to the curing operation. FIG. 4B depicts a sliding door 402 of the curing station 401 being opened. FIG. 4C depicts a retractable cart 403 in an outer stop position. FIG. 4D depicts a rotary union mount 404 in a lowered position. FIG. 4E depicts a container 405 being installed on the retractable cart 403 with a transport mount 406. In FIG. 4F the transport mount has been withdrawn and a gas line connection 407 has been made to the drum via after the rotary mount 404 has been raised. In certain embodiments there may be multiple gas line connections which may, for example, introduce process gas to the container 405 or remove used gas from the container 405. FIG. 4G depicts the retractable cart 403 having been unlocked and slid into an inner stop position. FIG. 4H depicts the sliding door 402 having been lowered, with the rotary mount 404 extending outside of the curing station so that gas connections may be maintained. Next, a curing cycle may be conducted on the build material powder. FIG. 4I depicts that after the curing process is complete, a curtain hood 408 is moved to a retracted position where a cooling system 409 cools the build material powder in the container 405. Next, as depicted in FIG. 4J, the curtain hood 408 is replaced and the sliding door 402 opened. As depicted in FIG. 4K the retractable cart 403 is pulled to the outer stop position and the rotary mount 404 is lowered. As depicted in FIG. 4L, the transport mount 406 is connected to the container 405 and used to transport the container 405 for further use. As depicted in FIG. 4M, the curing station 401 is then ready for further use.

Temperatures used for curing may depend on several factors including the material being cured and the state of the material being cured (virgin powder vs recycled powder). A typical temperature used for stainless steel build material powder may be in the range 100-200° C. For curing virgin powder, the temperature required may be as high as 300° C. using air. Gas flow rates may be provided such that the entire volume of the drum is replaced in a given time. A typical gas flow could be 1-100 slpm. Gas flow rate may be initially higher to displace air (oxygen) from the drum prior to heating. In an embodiment, the heating system may employ an inductive heating mechanism for heating the drum, or for heating the build material powder directly.

In some embodiments, the rate of gas flow supply into the drum and exhaust rates out of the drum, may each be monitored, for example by means of mass flow meters, or by any other suitable means for measuring a gas flow rate. The supply and exhaust flow rates may be compared to one another, and a control system may be configured to determine a leak rate as the difference between supplied gas and exhausted gas. The actual leak rate may be compared against a predetermined maximum allowable leak rate, and used to trigger certain actions, including for example alerting an operator of the curing station of the leak rate, or pausing or aborting a powder curing step. In some embodiments, a leak rate may be monitored during a heating or cooling process, resulting in a temperature change of the gas. In such a case of a temperature change, a leak rate calculation may be modified to account for the volume change resulting from gas temperature change, for example by using the ideal gas law to calculate a gas volume change, or my means of modeling, or by means of calibration based on experimental measurements, or by any suitable means as will be understood by one skilled in the art.

In the process of binder jetting additive manufacturing, a build material powder is delivered to and spread upon a build surface and a binding agent (or binder or ink) is deposited on the build material powder to at least partially bind the build material powder to form a slice of a 3D object. By repeating the steps of delivering a build material powder, spreading a build material powder, and depositing a binder corresponding to a desired image, a 3D structure may be formed. This process is understood to occur in a binder jetting printer (or binder jet printer).

In certain embodiments, a binder jet printer may comprise a print enclosure with a number of modules configured to aid in or accomplish the additive manufacturing of parts and other objects from a build material powder. These modules may include: (1) an assemblage of printheads (or one printhead in certain embodiments), (2) an ink delivery system to supply the printheads with binder at flow and pressure conditions necessary for stable binder ejection from the printhead, (3) a build material supply module to deliver an amount of build material powder to a print surface within the printer, (4) a build material spreading module to spread an amount of build material powder which has been supplied to a print surface to a controlled thickness, (5) a container and motion system to contain the build material powder and during printing move the container to specific positions (e.g., by moving in a first direction relative to a least one of the modules (1)-(4)) to enable the fabrication of successive layers of an object. In some embodiments, the printer may comprise additional modules including: (6) devices configured to reduce, prevent, or remove build material powder and/or ejecta from the printhead that may become suspended in an atmosphere in the print enclosure, including, according to certain embodiments, devices which deposit liquids (e.g., water, alcohol, oils, and the like) onto a surface of the build material powder to alter the cohesive characteristics of the powder, devices which control and/or provide a flow of gas to remove and/or filter suspended ejecta, (7) devices configured to control the gaseous atmosphere within the print enclosure relative to a gaseous atmosphere surrounding the binder jet printer, and (8) at least one reciprocating mechanism to provide relative motion between the container containing build material powder and at least one of the modules (1) to (4) in a second direction different from the first direction of the container and indexing system.

Build material powders may be sensitive to certain gaseous atmospheres. According to certain embodiments, it is desirable to prevent, minimize, or otherwise avoid gaseous communication between certain gaseous species and specific metal powders. For example, a copper build material powder may oxidize when in contact with air. In certain embodiments of the binder jetting printing process, such an oxidation of copper may be deleterious to the printing process for at least the reason that the oxidation may be uncontrolled and may introduce uncertainty into certain aspects of the binder jet printing process. In certain embodiments, a build material powder may be reactive (e.g, pyrophoric or explosible) with moisture and the build material powder should be kept separate from a base level of moisture contained in ambient air (e.g., room humidity). In certain embodiments, a build material powder may not be chemically sensitive (e.g., prone to oxidation, explosibility, pyrophoricity, or other means of chemical reaction) but may exhibit a change in physical properties such as the ability of the build material powder to flow. In the case where the flow characteristics of the powder will vary, degrade, or otherwise change, maintaining a consistent atmosphere around the build material powder may be required.

In another embodiment, build material powders may be reactive (e.g. pyrophoric or explosible) in the presence of oxygen and ignition sources capable of providing energy above the minimum ignition energy or temperatures above the minimum ignition temperature of the powder. Certain of the process modules (1) to (8) may provide sufficient energy or temperature to exceed these ignition limits, creating a condition in which a reaction may occur. In such cases, it may be desirable to maintain the printing environment in an inerted state, with the oxygen concentration of the atmosphere maintained below a predetermined concentration which is lower than the limiting oxygen concentration, or the concentration below which combustion of the build material powder does not readily occur. A typical target oxygen concentration may be 2%, which is below a typical limiting oxygen concentration of 4-15% for commonly printed materials.

In the process of binder jet additive manufacturing, a build material powder is typically supplied to a binder jet printer and some amount of this build material powder is bound using a binder to form objects. These objects are provided with various names in the field of art, and may be referred to as green parts, but are sometimes also referred to as brown parts. In certain embodiments, the objects formed may include parts that, as one skilled in the art will appreciate, may undergo subsequent post-processing steps (perhaps including a curing, drying, or crosslinking step) to improve the mechanical properties (such as strength, fracture toughness, elongation to failure, and the like) of the bound object.

### Post-Processing

In certain embodiments, post-processing (such as curing, drying, crosslinking, and the like) may be optionally performed to improve the mechanical properties of objects fabricated from build material powder and binder. In certain embodiments, the improvement of mechanical properties attained during the post-processing steps may reduce breakages of objects that can occurr during the removal of unbound build material powder from the surfaces of the objects formed from binder and build material powder. This process of removing unbound build material powder (that is, powder which is not held or adhered to an object with binder) is often termed “depowdering”. As one skilled in the art may appreciate, several approaches may be pursued to depowder parts.

### Objects: Parts and Supports

Several types of objects may be printed using a binder jet printer. In certain embodiments, a single object may comprise a single part. In certain embodiments, a single object may comprise a series of parts connected with a mechanical linkage permitting relative motion (such as a hinge, slide, or other element). In certain embodiments, a single object may comprise a series of parts connected with a mechanical linkage in which motion is prohibited, substantially prohibited, or the parts are otherwise fully constrained in all directions of translation and rotation. In certain embodiments, a single object may comprise a series of parts connected with at least one mechanical linkage permitting motion in at least one direction, and prohibiting motion in at least one other direction (such as, for example, in a sliding mechanism permitting motion in a first sliding direction with constraint imposed in a second constraining direction orthogonal to the first direction). In certain embodiments, a single object may comprise a part and a supporting structure, where the supporting structure may be configured to touch, abut, hold, cradle, or otherwise contact the part at or through at least one point across opposed surfaces of the part and support structure. In certain embodiments, the support structure may provide a means of support to the part. In certain embodiments, the means of support may be mechanical, such that the support structure, through the at least one point, carries a stress or force transmitted through or imposed upon the part. In certain embodiments, the part and the support may be printed in a first configuration and brought to contact in a second configuration, where the second configuration enables the support structure to provide support to the part.

### Thermal Processing

Following binder jet printing and optional post-processing of the object, the object may be further subjected to thermal processing, according to certain embodiments. The thermal processing may include the steps of debinding and sintering of the object.

### Debinding

During debinding, binder is removed from the object. Debinding may be performed in any suitable chamber or enclosure. In certain embodiments, a suitable chamber or enclosure may include a means of heating the object, a means of providing a flow of process gas, a means of evacuating a process gas, and a means of controlling a pressure of the process gas, as will be appreciated by one skilled in the art.

Not being bound by theory, debinding may remove binder by a thermally activated process of evaporation, sublimation, combustion, oxidation, or degradation, according to certain embodiments. Depending upon the specific binder and build material powder materials in the object undergoing debinding, the debinding process may be tailored to achieve the desired amount of debinding.

In certain embodiments, the debinding process may begin at any temperature from the list of starting debinding temperatures: 200, 250, 300, 350, 400, or 450 degrees centigrade. In certain embodiments, the debinding process may end at any temperature from the list of ending debinding temperatures: 250, 300, 350, 400, 500, or 600 degrees centigrade. For example, a debind process may occur between 200 and 350 degrees centigrade, or may occur between 300 and 600 degrees centigrade. It should be understood by one skilled in the art that the starting debinding temperature will be less than the ending debinding temperature.

The debinding process may require the maintenance of a specific gaseous atmosphere surrounding the objects, according to certain embodiments. The gaseous atmosphere may include the gases argon, nitrogen, oxygen, hydrogen, helium, carbon dioxide, carbon monoxide, ammonia, methane, air, or the like. According to certain embodiments, the gaseous atmosphere may be a mixture of gases. According to certain embodiments, the gaseous atmosphere may be substantially absent and a vacuum may exist about the parts. According to certain embodiments, a gaseous atmosphere may be provided by a process gas.

The debinding process may require, or more optimally perform with a specific pressure or range of pressures of a process gas. According to certain embodiments, the pressure of the gaseous atmosphere during debinding may be equal to or may exceed 1 atmosphere. According to certain embodiments, the pressure of the gaseous atmosphere during debinding may be between 0.5 and 1 atmosphere. According to certain embodiments, the pressure of the gaseous atmosphere may be between 0.01 and 0.5 atmospheres. According to certain embodiments, the pressure of the gaseous atmosphere may be between 0.01 and 10 Torr. According to certain embodiments, the pressure of the gaseous atmosphere may be less than 0.01 Torr. In certain embodiments, a desired pressure may be maintained with a vacuum pump and a supply of process gas, where the volume of gas removed by the pump and the supply of process gas at least partially determine the pressure within the debind chamber.

### Sintering

Following the removal of at least a portion of the binder by the debinding process, the object may then be sintered, according to certain embodiments. In certain embodiments, the objects may be sintered without the removal of the binder, or without the binder removal step.

Not being bound by theory, during the process of sintering, the build material powder is heated to result in the joining of the build material powders to form a sintered object. The sintered object may exhibit a density larger than the density of the object prior to sintering, according to some embodiments. The object may be sintered without the melting of any build material powder, according to certain embodiments. The object may be sintered with the melting of only a portion of the build material powder, according to certain embodiments.

The process of sintering typically occurs in a sintering furnace, as will be appreciated by one skilled in the art. According to some embodiments, the sintering furnace may include a means of heating the object to be sintered. According to some embodiments, the sintering furnace may include a means of providing a flow of sintering process gas to the objects to be sintered, in such a way that the gaseous atmosphere around the objects to be sintered is at least partially controlled. According to some embodiments, the sintering furnace may include a means of controlling the pressure of a gaseous atmosphere around the objects during the sintering process (the “sintering pressure”). According to some embodiments, the means of controlling the pressure of a gaseous atmosphere around the objects during sintering may include a vacuum pump and at least one conduit to enable gaseous communication between a chamber housing the object to be sintered and the vacuum pump.

The gaseous atmosphere surrounding the object during sintering is often an important aspect of the sintering process. According to certain embodiments, the gaseous atmosphere may be comprised of hydrogen, helium, argon, nitrogen, carbon dioxide, carbon monoxide, methane, forming gas (a mixture of hydrogen and argon), ammonia, or air. According to certain embodiments, the gaseous atmosphere may be comprised of a mixture of gasses (95% nitrogen and 5% hydrogen by weight, for example). Careful selection of the gaseous atmosphere may promote certain mechanisms of sintering and lead to a desired amount of densification. As will be understood by one skilled in the art, the composition of the gaseous atmosphere surrounding the object during sintering may change during the sintering process, for example according to a predetermined schedule and in a coordinated fashion with the temperature, pressure, and flow rates as a function of time.

The pressure of the gaseous atmosphere surrounding the object during sintering is often an important aspect of the sintering process. According to certain embodiments, it is desirable to decrease the pressure in the sintering furnace to enhance the densification (that is, to increase the density) of an object undergoing sintering. According to certain embodiments, it is desirable to increase the pressure in the sintering furnace to enhance the densification (that is, to increase the density) of an object undergoing sintering. The selection of pressure is typically determined by the elements from which the build material powder is comprised in addition to the interaction of the elements with the gaseous atmosphere. In certain embodiments, the pressure of the gaseous atmosphere surrounding the object during sintering is at least 1 atmosphere and up to 5 atmospheres. In certain embodiments, the pressure of the gaseous atmosphere surrounding the object during sintering is at least 0.5 atmosphere and less than 1 atmosphere. In certain embodiments, the pressure of the gaseous atmosphere surrounding the object during sintering is at least 0.1 atmosphere and less than 0.5 atmosphere. In certain embodiments, the pressure of the gaseous atmosphere surrounding the object during sintering is at least 0.001 Torr atmosphere and less than 10 Torr. In certain embodiments, the pressure of the gaseous atmosphere surrounding the object during sintering is less than 0.001 Torr. As will be understood by one skilled in the art, the pressure of the gaseous atmosphere surrounding the object during sintering may change during the sintering process, for example according to a predetermined schedule and in a coordinated fashion with the temperature, composition, and flow rates as a function of time.

In some embodiments, the steps of debinding and sintering may occur during a sequentially in the same chamber, as part of a processing operation. For example, a single furnace may be used to first debind a part by controlling its temperature through starting and ending debind temperatures, and continuing to sintering temperatures without first cooling the part from the ending debind temperature.

### Build Material Powders

In certain embodiments, the build material may be any finely divided material or powder. The finely divided material may be a metal, oxide ceramic, non-oxide ceramic, glass, cermet, organic material, carbide, nitride, or any mixture, according to certain embodiments.

In certain embodiments, the build material may comprise a metallic powder. In certain embodiments, the metallic powder may comprise a pure element (such as elemental copper or iron). In certain embodiments, the metallic powder may comprise an alloy of metallic elements to form a specific grade of metal, such as 17-4 stainless steel, 316 stainless steel, 316L stainless steel, 4140 low alloy steel, Inconel 718, Inconel 625, 6061 aluminum, 7075 aluminum, Ti-6Al-4V titanium, F75 Co—Cr—Mo, or any other alloy capable of being produced in a powdered or finely-divided form. In certain embodiments, the metallic powder may comprise a mixture of powdered metallic elements purposed to achieve the desired chemical specification of an alloyed metal (for example, a mixture including elemental Co, Cr, and Mo powders to form an F75 alloy, or a mixture including Fe, Cr, V, C, Mn, Si, and Ni to form a stainless steel). In certain embodiments, the build material may comprise a metallic powder where the metal is a refractory metal (such as tungsten, tantalum, niobium, rhenium, molybdenum, hafnium, zirconium, or the like).

In certain embodiments, the build material may comprise a ceramic powder. In certain embodiments, the ceramic powder may comprise alumina, zirconia, yittria-stabilized zirconia, mullite, silica, chromia, spinel, and the like. In certain embodiments, the build material may be a mixture of ceramic powders (for example, silica and alumina, or magnesium oxide and alumina).

In certain embodiments, the build material may be naturally derived, as an organic material. In certain embodiments, the organic material may comprise a wood flour, sawdust, cellulosic fiber, or the like.

In certain embodiments, a binder jet printer may include a container to contain the build material powder and printed structures. The container may be indexable moveable relative to the build material delivery and spreading mechanisms, and may also be indexable relative to an inkjet head or heads which deposit the binding agent in a desired pattern to form a slice of a 3D structure on the surface of a powder bed. As may be appreciated by one skilled in the art, the ability of the binder jet printer to accurately position and index the bed is crucial to the performance of the binder jet printer, and, specifically, is crucial to the layer-to-layer tolerance of the objects (or parts) produced by the binder jet printer.

What is claimed is:

1. A method of curing build material powder, comprising-the steps of:
providing an amount of build material powder to be cured;
providing a container sealable with respect to a gaseous atmosphere present about the exterior of the container;
sealing the amount of build material powder within the container;
installing the container in a powder curing apparatus, the curing apparatus including a heating system and an agitation system;
applying heat to the build material powder within the container using the heating system according to a temperature profile;
during the heating, providing motion to the build material powder within the container using the motion system, such that a first portion of the build material powder is conveyed away from an interior surface of the container, and a second portion of the build material powder is conveyed toward an interior surface of the container;

2. The method of claim 1, further comprising, during the heating, at least one of providing to an interior of the container, via a gas inlet in the container, an inflow of process gas, removing from the container, via a gas outlet in the container, an outflow of used gas, and applying a vacuum to the interior of the container.

3. The method of claim 1 further comprising, during the heating in the container, monitoring that the container is hermetically sealed with respect to an ambient gaseous environment.

4. The method of claim 3 wherein the monitoring of the container includes measuring a differential pressure between the interior of the container and the ambient environment.

5. The method of claim 1 wherein the container is a drum.

6. The method of claim 5 wherein the agitation system agitates the build material powder by rotating the drum.

7. The method of claim 6 wherein the rotating the drum at a predetermined rate profile includes operating a series of caster wheels interfacing with a plurality of circumferential rings on the drum.

8. The method of claim 6 wherein the rotation is around a longitudinal axis of the drum that is parallel to an ambient ground.

9. The method of claim 1 wherein the heating system includes at least one infrared heater configured to operate at a temperature greater than a minimum ignition temperature of the build material powder.

10. The method of claim 1 further comprising:
cooling the container with a cooling system after the heating in the container.

11. A station for curing build material powder, comprising:
a frame defining an interior volume, the interior volume configured to receive a container enclosing build material powder;
a heating system attached to the frame and configured to heat a surface of the container;
an agitation system attached to the frame and configured to impart motion to a surface of the container, such that a portion of the build material powder contained within the container will move relative to a surface of the container enclosing build material powder; and
a gas system configured to at least one of inject and remove gas from the container.

12. The station of claim 11 further comprising a cooling system attached to the frame and configured to cool at least one surface of the container

13. The station of claim 11 wherein agitation system is configured to rotate the container.

14. The station of claim 13 wherein the frame includes a sliding cart for receiving the drum.

15. The station of claim 13
wherein the heating system includes at least one infrared heater configured to reach a temperature greater than a flash temperature of the build material powder, and
wherein the station further comprises a reflective curtain hood attached to the frame and configured to at least partially surround the container while it is heated.

16. (canceled)

17. The station of claim 15 wherein the reflective curtain hood is movable from a closed position to a retracted position.

18. The station of claim 17 wherein when the reflective curtain hood is in the retracted position the drum is exposed to the cooling system.

19. The station of claim 13
wherein the container is a drum and the agitation system includes a drum rotation system having a rotating bar configured to interface with a complementary bar on a base of the drum,
wherein the cooling system includes at least one fan, and
wherein the frame includes a rotary union that is lowerable for facilitating loading and unloading of the container.

20. (canceled)

21. (canceled)

22. A method of curing build material powder, comprising:
opening a sliding door on a curing station;
sliding out a retractable cart of the curing station to a stop position;
lowering a rotary union mount of the curing station;
loading a drum to the rotary union mount of the curing station;
raising the rotary union mount of the curing station;
connecting a plurality of gas connections on the drum to a plurality of gas lines;
unlocking the retractable cart of the curing station and sliding it to an inner stop position; and
closing the sliding door of the curing station; and
conducting a curing process.

23. The method of claim 19, further comprising:
opening a reflective curtain hood of the curing station;
operating at least one fan of the curing station to cool the drum;
closing a heat shield of the curing station;
opening the sliding door of the curing station;
sliding out the retractable cart of the curing station;
undoing the gas connections;
lowering the rotary union mount of the curing station; and
removing the drum.
